(19) United States
(12) Patent Application Publication
(10) Pub. No.: US 2017/0001883 A1
(43) Pub. Date: Jan. 5, 2017

(54) WATER TREATMENT SYSTEM AND WATER TREATMENT METHOD

(71) Applicant: Hitachi, Ltd., Tokyo (JP)

(72) Inventors: Shinichi YOSHIKAWA, Tokyo (JP); Katsuhiro MIBU, Tokyo (JP); Yukiko ICHIGE, Tokyo (JP); Katsuhiko SHIMIZU, Tokyo (JP); Hideaki KUROKAWA, Tokyo (JP)

(73) Assignee: Hitachi, Ltd., Tokyo (JP)

(21) Appl. No.: 15/181,472

(22) Filed: Jun. 14, 2016

(30) Foreign Application Priority Data
Jun. 30, 2015 (JP) 2015-131209

(51) Int. Cl. C02F 1/44; B01D 61/08; B01D 61/02

(52) U.S. Cl. CPC C02F 1/441; B01D 61/025; B01D 61/08; C02F 2103/08

(57) ABSTRACT

Provided are a water treatment system and a water treatment method capable of downsizing a facility and inexpensively producing freshwater. A water treatment system includes: a first reverse osmosis treatment device for separating wastewater into desalinated permeate water and concentrated wastewater; a mixing unit for mixing the separated concentrated wastewater and intake seawater; a second reverse osmosis treatment device for separating mixed water obtained by mixing the concentrated wastewater and the seawater into desalinated permeate water and concentrated mixed water; and a return pipe for returning a portion of the separated concentrated mixed water to the mixing unit. The water treatment method includes the following steps: mixing intake seawater with wastewater; separating the mixed water into permeate water and concentrated mixed water; re-mixing a portion of the concentrated mixed water with the mixed water; and producing freshwater by re-separating the re-mixed water into permeate water and concentrated mixed water.

### CROSS REFERENCE TO RELATED APPLICATIONS

This application claims the foreign priority benefit under Title 35, United States Code, §119 (a)-(d) of Japanese Patent Application No. 2015-131209, filed on Jun. 30, 2015, the disclosure of which is herein incorporated by reference in its entirety.

### TECHNICAL FIELD

The present invention relates to a water treatment system and a water treatment method.

### BACKGROUND ART

There has been known a desalination system for producing industrial water, drinking water or the like by desalinating seawater or brine by reverse osmosis treatment with RO (Reverse Osmosis) membranes. In a seawater desalination system, the seawater or the like taken from the ocean or the like is subjected to a pretreatment to remove suspended matter such as particles, and then freshwater is produced by reverse osmosis treatment.

Conventionally, there has been also known a water treatment system (water treatment system according to a comparative example) for producing freshwater from each of intake seawater and wastewater such as sewage by reverse osmosis treatment. FIG. 3 is a view showing a schematic configuration of the water treatment system according to the comparative example. As shown in FIG. 3, a water treatment system 10S according to the comparative example is composed of a wastewater treatment system including a wastewater treatment tank 101 and a low pressure RO membrane unit 103, and a seawater treatment system including a pretreatment facility 105 and a high pressure RO membrane unit 107.

In the water treatment system 10S, the wastewater such as sewage is supplied to the wastewater treatment tank 101 equipped with a membrane separation device by a pump P111. Subsequently, the wastewater is subjected to a decomposition treatment by activated sludge based on membrane bioreactor process in the wastewater treatment tank 101. Then, the wastewater subjected to a decomposition treatment of organic matter is clarified by suction to the membrane separation device by a pump P112, and then is pumped to the low pressure RO membrane unit 103 by a high pressure pump P114.

In the low pressure RO membrane unit 103, the wastewater is subjected to reverse osmosis treatment by a semipermeable membrane. Permeate water (product water) desalinated by reverse osmosis treatment is recovered to be used in various applications. On the other hand, concentrated water (concentrated wastewater) having a salt concentration concentrated by reverse osmosis treatment is sent to the seawater treatment system.

Further, in the water treatment system 10S, the seawater taken from the ocean or the like is supplied to the pretreatment facility 105 by a pump P121. Subsequently, the seawater is subjected to a pretreatment for the purpose of removal of particles or prevention of reproduction of marine organisms in the pretreatment facility 105. Then, the pretreated seawater is sent to a pump P122, to merge with the concentrated wastewater separated in the wastewater treatment system, and then is pumped to the high pressure RO membrane unit 107 by a high pressure pump P125.

In the high pressure RO membrane unit 107, the seawater which has merged with the concentrated wastewater is subjected to reverse osmosis treatment by the semipermeable membrane. Permeate water (product water) desalinated by reverse osmosis treatment is recovered to be used in various applications in the same manner as in the wastewater treatment system. On the other hand, concentrated water (brine) having a salt concentration concentrated by reverse osmosis treatment is treated or released.

A salt concentration of the seawater is generally in a range of about 3% to 4%. In contrast, a salt concentration of the wastewater supplied to the low pressure RO membrane unit 103 included in the wastewater treatment system is generally a low concentration of about 0.1%. Therefore, in the water treatment system 10S according to the comparative example, the concentrated wastewater separated in the wastewater treatment system and the seawater subjected to reverse osmosis treatment in the seawater treatment system merge together, and thus the salt concentration is reduced and osmotic pressure is reduced.

As a result, reverse osmotic pressure applied to the semipermeable membrane included in the high pressure RO membrane unit 107 is small, and thus operation power of the high pressure pump 125 and the like is reduced. Further, in the water treatment system 10S, a portion of the concentrated wastewater separated in the wastewater treatment system is not discarded but is subjected to reverse osmosis treatment in the seawater treatment system, and thus there is also an advantage that an amount of the product water is increased.

For example, Patent Document 1 is known as a technology related to a water treatment system for producing freshwater from each of the seawater and the wastewater by reverse osmosis treatment in this manner.

### CITATION LIST

### Patent Literature

[Patent Document 1]

Japanese Patent Publication No. 4481345

### SUMMARY OF INVENTION

### Technical Problem

The water treatment system as disclosed in Patent Document 1 for producing freshwater from the seawater and the wastewater by reverse osmosis treatment is often introduced into a region of poor freshwater resources and of chronic water shortage. In such a region, a function of water passage for discharging rainwater, domestic wastewater, industrial wastewater or the like is often vulnerable, and a flow rate of the wastewater supplied to the water treatment system tends to be difficult to be stable. Therefore, when attempting to stably produce an amount of freshwater to meet the demand in such a region, a lot of raw water must be prepared with the seawater instead of the wastewater.

However, in order to increase an intake amount of the seawater, it is necessary to provide a big scale water intake facility and pretreatment facility along with the water treatment system. When providing the big scale water intake facility and pretreatment facility, an initial facility cost of the water treatment system is increased, and it takes a significant power cost for operating the pumps and the like during operation. Further, when increasing the intake amount of the seawater, cost of chemical agents such as flocculant, fungicide, dechlorination agent, scale inhibitor and pH adjusting agent is also increased in proportion to the scale of the water intake facility and pretreatment facility.

Therefore, a purpose of the present invention is to provide a water treatment system and a water treatment method capable of downsizing a facility and inexpensively producing freshwater.

### Solution to Problem

In order to solve the above problems, a water treatment system according to the present invention includes: a first reverse osmosis treatment device for separating wastewater or treated wastewater into desalinated permeate water and concentrated wastewater by reverse osmosis treatment; a mixing unit for mixing the separated concentrated wastewater and intake seawater; a second reverse osmosis treatment device for separating mixed water obtained by mixing the concentrated wastewater and the seawater into desalinated permeate water and concentrated mixed water by reverse osmosis treatment; and a return pipe for returning a portion of the separated concentrated mixed water to the mixing unit.

Further, a water treatment method according to the present invention includes the following steps: mixing intake seawater with wastewater or treated wastewater; separating mixed water obtained by mixing the seawater with the wastewater or the treated wastewater into desalinated permeate water and concentrated mixed water by reverse osmosis treatment; re-mixing a portion of the concentrated mixed water with the mixed water obtained by mixing the seawater with the wastewater or the treated wastewater; and producing freshwater by re-separating mixed water re-mixed with the concentrated mixed water into desalinated permeate water and concentrated mixed water by reverse osmosis treatment.

### Advantageous Effects of Invention

According to the present invention, it is possible to provide a water treatment system and a water treatment method capable of downsizing a facility and inexpensively producing freshwater.

### BRIEF DESCRIPTION OF DRAWINGS

FIG. 1 is a schematic configuration diagram of a water treatment system according to an embodiment of the present invention;

FIG. 2 is a schematic configuration diagram of a water treatment system according to a modification of the present invention;

FIG. 3 is a schematic configuration diagram of a water treatment system according to a comparative example;

FIG. 4A is a diagram for explaining operation by return of concentrated mixed water in a water treatment system and showing salt concentration and flow rate in the water treatment system according to the comparative example; and

FIG. 4B is a diagram for explaining operation by return of concentrated mixed water in a water treatment system and showing an example of salt concentration and flow rate in the water treatment system according to the embodiment of the present invention.

### DESCRIPTION OF EMBODIMENTS

Hereinafter, a water treatment system and a water treatment method according to an embodiment of the present invention will be described. Note that, in the following drawings, the same components are denoted by the same reference numerals, and duplicated description will be omitted.

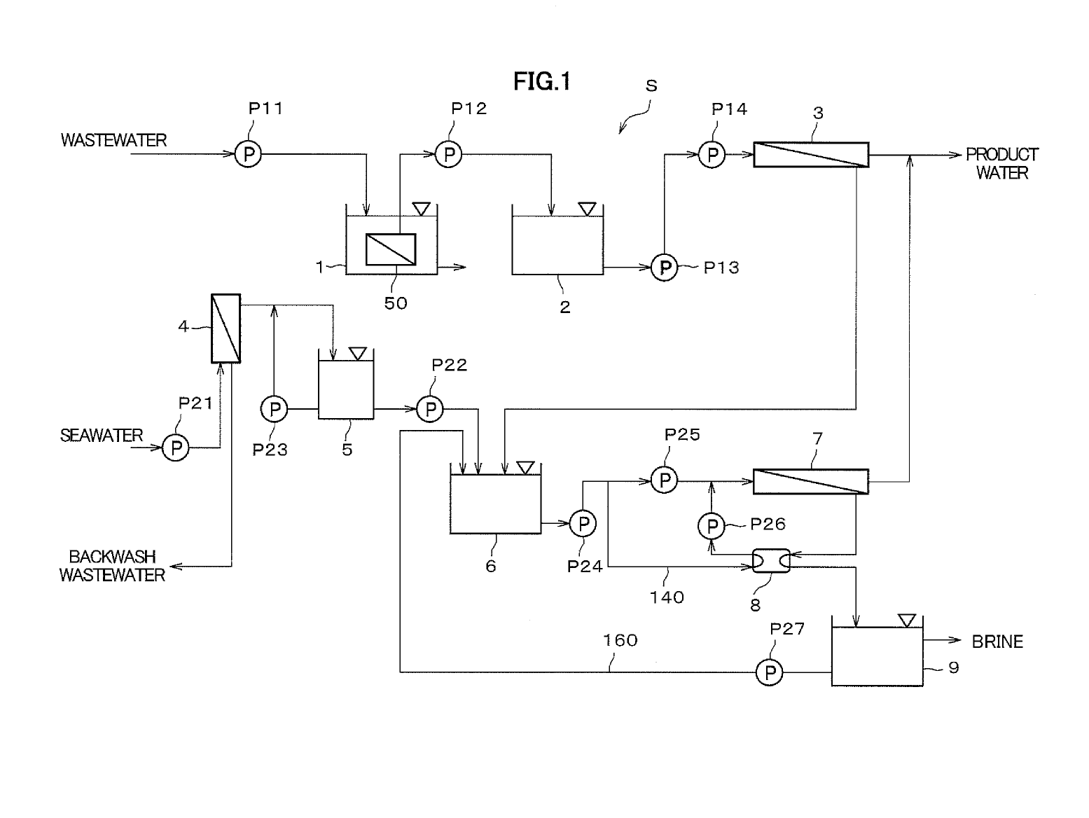

FIG. 1 is a schematic configuration diagram of a water treatment system according to an embodiment of the present invention. As shown in FIG. 1, a water treatment system S according to the present invention includes a wastewater treatment tank 1, a water supply tank 2, a first RO membrane unit (first reverse osmosis treatment device) 3, a filter device 4, a filtered water tank 5, a mixing tank (mixing unit) 6, a second RO membrane unit (second reverse osmosis treatment device) 7, an energy recovery device 8, a concentrated water receiving tank 9, a branch pipe 140 and a return pipe 160.

The water treatment system S is a facility capable of producing freshwater having a reduced salt concentration from each of seawater and wastewater (or treated wastewater) by reverse osmosis treatment. In the water treatment system S, the wastewater treatment tank 1, the water supply tank 2 and the first RO membrane unit 3 constitute a wastewater treatment system, and the filter device 4, the filtered water tank 5, the mixing tank 6 and the second RO membrane unit 7 constitute a seawater treatment system.

As shown in FIG. 1, the water treatment system S is supplied with the wastewater as raw water to be subjected to reverse osmosis treatment. In particular, sewage, industrial wastewater or the like is supplied as the wastewater. The sewage may be, for example, rainwater, domestic wastewater, business wastewater discharged from a workplace, or may be a mixture thereof. Further, the wastewater may contain organic matter or inorganic matter as a contaminant component. As shown in FIG. 1, the wastewater as raw water is pumped up, for example, from sewer, drainage or the like, and is supplied to the wastewater treatment tank 1 by a pump P11 after filtering process or the like is performed as appropriate to remove fine particles which are impurities.

The wastewater treatment tank 1 is a treatment tank to remove or decompose the contaminants contained in the wastewater, or to remove suspended matter from the wastewater. In FIG. 1, the wastewater treatment tank 1 is a membrane separation activated sludge treatment tank (membrane bioreactor; MBR) equipped with a membrane separation device. The MBR removes or decomposes organic matter or the like contained in the wastewater by activated sludge, and it is possible to perform clarification process of the suspended matter such as sludge contained in untreated water by a separation membrane 50 such as a microfiltration membrane (MF membrane) or an ultrafiltration membrane (UF membrane).

From the wastewater supplied to the wastewater treatment tank 1, the contaminants such as organic matter and inorganic matter are removed by activated sludge held in the wastewater treatment tank 1. Further, a portion of the inorganic matter or the like contained in the wastewater is removed from the wastewater together with excess sludge. Then, the wastewater is sucked by a pump P12, so that the suspended matter such as the activated sludge or colloid produced by biodegradation are removed by the separation membrane 50 such as the microfiltration membrane or the ultrafiltration membrane, and then is sent to the water supply tank 2.

The water supply tank 2 temporarily stores the clarified wastewater, to equalize an amount of the wastewater to be supplied to the first RO membrane unit 3. That is, since the wastewater above a certain level is stored in the water supply tank 2, the reverse osmosis treatment can be stably performed in the first RO membrane unit 3 without being significantly affected by variation of supply amount of the wastewater.

The wastewater is sucked from the water supply tank 2 by a pump P13, and is boosted by a high pressure pump P14, to be pumped to the first RO membrane unit 3. The high pressure pump P14 boosts pressure of the wastewater to a pressure required to obtain a total amount of untreated water in a RO membrane included in the first RO membrane unit 3. In particular, the high pressure pump P14 boosts the pressure of the wastewater to generate a membrane pressure difference required in consideration of water flow path resistance up to the first RO membrane unit 3 and osmotic pressure generated in the RO membrane due to concentrations of the untreated water and concentrated water, in addition to a membrane permeation resistance of the RO membrane.

The first RO membrane 3 has an element constituted by, for example, the RO membrane and a water collecting pipe, and is configured to include a pressure vessel filled with a plurality of elements. The RO membrane is a semipermeable membrane having a property of hardly allowing ions or small molecules such as salt to pass therethrough while allowing water to easily pass therethrough. A module constituted by the vessel filled with the elements may be provided in plurality so as to be arranged in series form or in parallel form.

The wastewater supplied to the first RO membrane unit 3 typically has a low salt concentration of about 0.1%, and osmotic pressure applied to the RO membrane is relatively low. Therefore, in the first RO membrane unit 3, the reverse osmosis treatment by the RO membrane is performed in a range of low reverse osmotic pressure of about 1 MPa to 2 MPa. The first RO membrane unit 3 is operated such that recovery rate of permeate water is within a range of about 50% to 70% in consideration of general performance of the RO membrane.

The supplied wastewater is separated into permeate water having a reduced salt concentration and concentrated wastewater having a concentrated salt concentration by reverse osmosis treatment. The permeate water separated in the first RO membrane unit 3 is used in appropriate applications such as drinking water, industrial water, agricultural water, landscaping water and hydrophilic water as product water. On the other hand, the separated concentrated wastewater is sent to the mixing tank 6.

Meanwhile, as shown in FIG. 1, the water treatment system S intakes seawater as the raw water to be subjected to reverse osmosis treatment. The seawater is intaken from, for example, the ocean by a pump P21, to be supplied to the filter device 4. As a water intake method of the seawater, it is possible to employ one of an indirect water intake method to intake seawater from, for example, below the seafloor and a direct water intake method to intake seawater in the seawater.

The filter device 4 performs filtering process to remove fine particles which are impurities from the intake seawater. The seawater is clarified by the filtering process in which the suspended matter and the fine particles of about several μm or more are removed therefrom. The filtering process in the filter device 4 can be performed by an appropriate method such as membrane separation by, for example, ultrafiltration membrane or microfiltration membrane, or separation by a filter material such as sand filtration, activated carbon filtration or diatomaceous earth filtration. Further, it is also possible to combine these various filtering processes by arranging a plurality of filter devices in series form.

The filtered water tank 5 receives and temporarily stores the seawater subjected to the filtering process, and adjusts a flow rate of the seawater to be sent to the mixing tank 6. The seawater stored in the filtered water tank 5 is sent to the mixing tank 6 by a pump P22.

The seawater stored in the filtered water tank 5 can be returned to the filter device 4 by a pump P23. The seawater received in the filtered water tank 5 after the filtering process is intermittently returned to the filer device 4 by the pump P23 at predetermined intervals or each time the filter device 4 reaches a predetermined filtration pressure due to accumulation of the processes. The filter device 4 is backwashed by returning the seawater, and the seawater having washed the filter device 4 is discharged as backwash wastewater, and is then released to the ocean or the like.

The mixing tank 6 is a treatment tank for mixing the intake seawater and the concentrated wastewater separated in the first RO membrane unit 3. In the mixing tank 6, the seawater and the concentrated wastewater having a salt concentration lower than the seawater are mixed together, to become mixed water having a salt concentration lower than the seawater. Further, in the water treatment system S, concentrated mixed water returned through the return pipe 160 from a subsequent stage is also re-mixed together with the seawater and the concentrated wastewater. The concentrated mixed water is concentrated water separated by reverse osmosis treatment in the second RO membrane unit 7, as described below.

The mixed water is sucked from the mixing tank 6 by a pump P24, and boosted by a high pressure pump P25, to be pumped to the second RO membrane unit 7. The high pressure pump P25 boosts pressure of the mixed water to a pressure required to obtain a total amount of untreated water in a RO membrane included in the second RO membrane unit 7. In particular, the high pressure pump P25 boosts the pressure of the wastewater to generate a membrane pressure difference required in consideration of water flow path resistance up to the second RO membrane unit 7 and osmotic pressure generated in the RO membrane due to concentrations of the untreated water and concentrated water, in addition to a membrane permeation resistance of the RO membrane. Further, a portion of the mixed water is sent to the energy recovery device 8 through the branch pipe 140 by the pump P24.

The second RO membrane unit 7 is configured to include a pressure vessel filled with a plurality of elements, each of which being constituted by, for example, the RO membrane and a water collecting pipe, in the same manner as the first RO membrane unit 3. A module constituted by the vessel filled with the elements may be provided in plurality so as to be arranged in series form or in parallel form.

The mixed water supplied to the second RO membrane unit 7 has a salt concentration higher than the concentrated wastewater and lower than the seawater, since the seawater, the concentrated wastewater (brine) of the first RO membrane unit 3, and the concentrated mixed water (brine) of the second RO membrane unit 7 are mixed together. Therefore, in the second RO membrane unit 7, the reverse osmosis treatment by the RO membrane is performed in a range of a reverse osmotic pressure of about 5 MPa to 8 MPa, which is lower than that of a typical seawater filtration system with RO membrane. The second RO membrane unit 7 is operated such that recovery rate of permeate water is within a range of about 50% to 70% in consideration of general performance of the RO membrane.

The supplied mixed water is separated into permeate water having a reduced salt concentration and concentrated mixed water having a concentrated salt concentration by reverse osmosis treatment. The permeate water separated in the second RO membrane unit 7 is used in appropriate applications as the product water together with the permeate water in the first RO membrane unit 3. On the other hand, the separated concentrated mixed water is sent to the energy recovery device 8.

The energy recovery device 8 converts energy of flow rate or pressure of the concentrated mixed water to energy for boosting pressure of the mixed water supplied to the second RO membrane unit 7, to supplementarily boost the pressure of the supplied mixed water. As the energy recovery device 8, for example, a positive replacement pump having a piston in a cylinder is provided. In the positive replacement pump, the concentrated mixed water is introduced into one cavity separated by the piston in the cylinder, and the mixed water is introduced into the other cavity. The piston is driven in a stroke movement by highly boosted pressure of the concentrated mixed water, and thus pressure exchange is performed between the mixed water and the concentrated mixed water. The energy recovery device 8 may be a rotary rotor, a turbo pump, a water turbine pump or the like other than the positive replacement pump.

The mixed water which has been boosted by the energy recovery device 8 is further boosted by the pump P26 to be merged with a remainder of the mixed water, and is pumped to the second RO membrane unit 7. On the other hand, the concentrated mixed water (brine) which has been depressurized by the energy recovery device 8 is received in the concentrated water receiving tank 9.

The concentrated water receiving tank 9 receives and temporarily stores the concentrated mixed water separated in the second RO membrane unit 7. The return pipe 160 is connected between the concentrated water receiving tank 9 and the mixing tank 6. The return pipe 160 forms a flow path for returning a portion of the concentrated mixed water separated in the second RO membrane unit 7 to the mixing tank 6. The portion of the concentrated mixed water received in the concentrated water receiving tank 9 is sent to the mixing tank 6 through the return pipe 160 by a pump P27, and is re-mixed with the seawater and the concentrated wastewater in the mixing tank 6. On the other hand, the remainder of the concentrated mixed water received in the concentrated water receiving tank 9 is treated or released.

With the above water treatment system S, since the return pipe 160 is provided for returning the portion of the concentrated mixed water to the mixing tank 6, the mixed water containing the seawater as a portion of the raw water is again supplied to the second RO membrane unit 7 without being again subjected to a pretreatment. Therefore, while maintaining an amount of the product water from the second RO membrane unit 7, it is possible to reduce an intake amount of the seawater to an extent corresponding to a return amount of the concentrated mixed water. Therefore, it is possible to downsize a seawater intake facility and a pretreatment facility, thereby inexpensively producing freshwater. Further, even when a flow rate of the wastewater to be supplied to the water treatment system is insufficient for the demand for the freshwater, a need to intake a large amount of seawater to supply it to the second RO membrane unit 7 is reduced, and thus it is also possible to reduce operating costs.

Next, a water treatment system according to a modification of the present invention will be described.

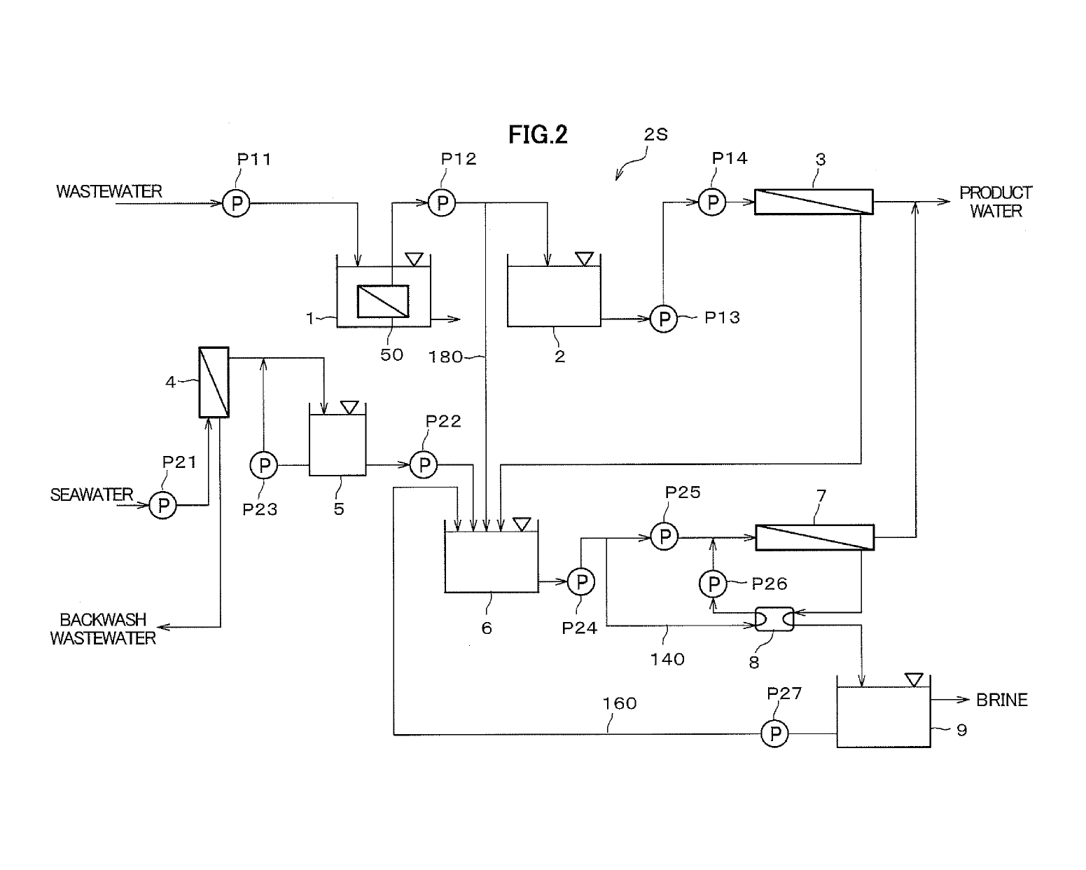

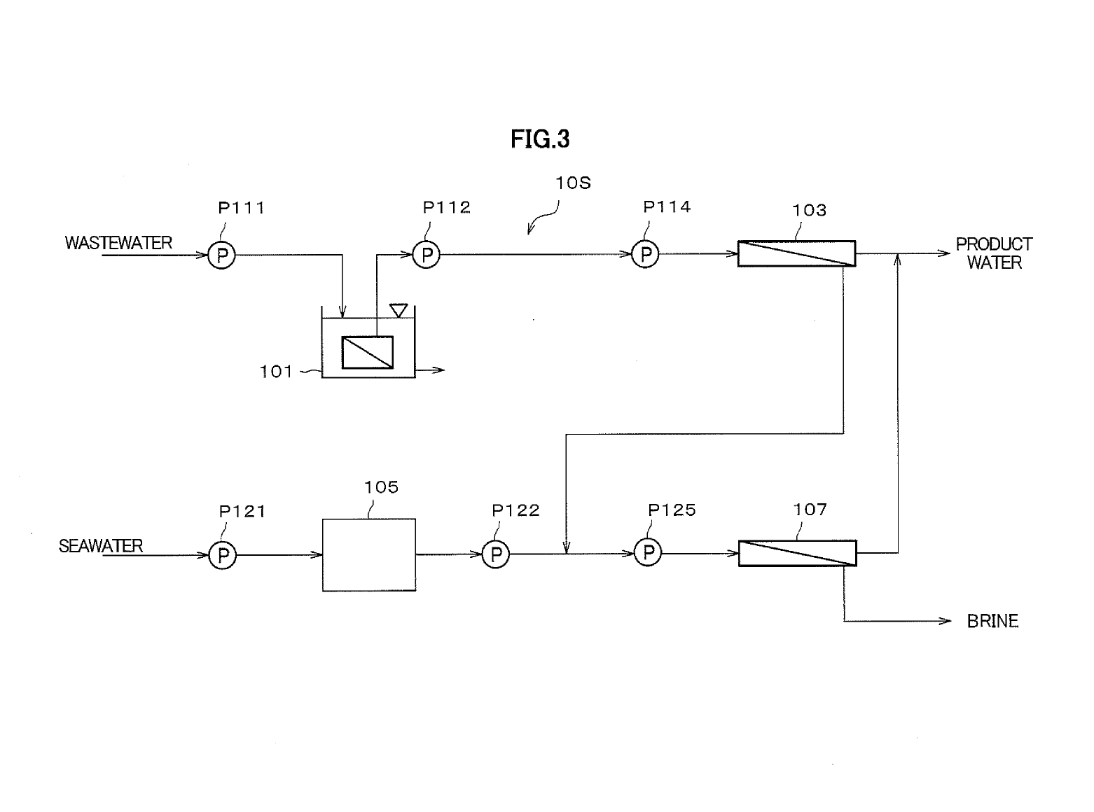

FIG. 2 is a schematic configuration diagram of the water treatment system according to the modification of the present invention. As shown in FIG. 2, similarly to the water treatment system S, a water treatment system 2S according to the modification includes the wastewater treatment tank 1, the water supply tank 2, the first RO membrane unit (first reverse osmosis treatment device) 3, the filter device 4, the filtered water tank 5, the mixing tank (mixing unit) 6, the second RO membrane unit (second reverse osmosis treatment device) 7, the energy recovery device 8, the concentrated water receiving tank 9, the branch pipe 140 and the return pipe 160. The water treatment system 2S according to the modification is different from the water treatment system S in that a supply pipe 180 connected to the mixing tank 6 is included in addition to these components.

The supply pipe 180 is branched from a conduit connecting the wastewater treatment tank 1 and the water supply tank 2, and forms a flow path for supplying the wastewater treated in the wastewater treatment tank 1 to the mixing tank 6 without passing through the first RO membrane unit 3. The supply pipe 180 serves to directly supply the wastewater, which is produced by removing or decomposing the contaminants and removing the suspended matter therefrom, to the mixing tank 6 by bypassing the water supply tank 2 and the first RO membrane unit 3. In particular, it is possible to provide, for example, a flow control valve, or a distribution valve for distributing the wastewater to the first RO membrane unit 3 at a predetermined flow rate ratio, at a branch point to the supply pipe 180.

With the above water treatment system 2S, since the supply pipe 180 is provided, it is possible to maintain an amount of water in the mixing tank 6 even in situations where an amount of the concentrated wastewater by reverse osmosis treatment in the first RO membrane unit 3 is temporarily reduced. For example, even when water supply is stopped for some of the plurality of modules included in parallel form in the first RO membrane unit 3 for the purpose of maintenance, repair or the like, it is possible to maintain an amount of water to be supplied to the second RO membrane unit 7 without increasing the flow rate of the seawater. Therefore, it is possible to downsize the seawater intake facility and the pretreatment facility, thereby inexpensively producing the freshwater. Further, even when water supply is stopped for some of the plurality of modules included in the first RO membrane unit 3, there is an advantage that it is not necessary to significantly change the return amount of the concentrated mixed water through the return pipe 160.

Next, details of water treatment method according to an embodiment of the present invention will be described based on an example of operating method of the water treatment system S. Note that, the following method can also be applied to the water treatment system 2S.

The water treatment method according to the present embodiment is a method in which the intake seawater and the wastewater or the treated wastewater are mixed together to be the mixed water, and the mixed water is subjected to reverse osmosis treatment to be separated into the concentrated mixed water and desalinated permeate water, and further the portion of the concentrated mixed water is re-mixed with the mixed water composed of the seawater and the wastewater or the treated wastewater. In addition to the seawater and the wastewater or the treated wastewater, the mixed water which has been re-mixed with the concentrated mixed water is subjected to reverse osmosis treatment, to be again separated into the concentrated mixed water and the desalinated permeate water so as to produce the fresh water. Then, by cyclically repeating the re-mixing of the concentrated mixed water and the reverse osmosis treatment of the mixed water, the fresh water as the product water is produced.

The water treatment method may be an embodiment in which the intake seawater is mixed with the concentrated water (concentrated wastewater) which has been previously separated by reverse osmosis treatment of the wastewater. The wastewater to be mixed with the intake seawater may be the treated water (treated wastewater) which has been previously subjected to removal/decomposition process for removing or decomposing the contaminants contained therein. As the removal/decomposition process, depending on the nature of the wastewater, it is possible to perform various biological treatments such as activated sludge treatment, anaerobic treatment and dephosphorization treatment, or various physicochemical processes such as adsorption process, ion exchange process, redox agent treatment, ozone treatment or ultraviolet treatment. Further, the suspended matter and the fine particles, which are impurities, are preferably removed from the intake seawater and the wastewater to be mixed with the seawater.

A ratio of the concentrated mixed water to be re-mixed with the seawater and the wastewater or the treated wastewater, to the concentrated mixed water separated by reverse osmosis treatment, is preferably set to an extent that an amount of the concentrated mixed water to be mixed per unit time does not exceed an amount of the seawater to be supplied per unit time. In the reverse osmosis treatment by the RO membrane, salt removal rate is high, and a majority of salt is separated as the concentrated water without passing through the RO membrane. Thus, the majority of salt contained in the seawater or the wastewater as the raw water must be discharged as the brine after reverse osmosis treatment. Therefore, by reducing the amount of the concentrated mixed water to be re-mixed to be smaller than the amount of the seawater to be supplied, it is prevented that a lot of salt is re-mixed.

In the water treatment system S, mixing of the intake seawater and the wastewater or the treated wastewater can be performed in the mixing tank 6, and the reverse osmosis treatment of the mixed water can be performed in the second RO membrane unit 7. Further, the re-mixing of the concentrated mixed water can be performed by returning the concentrated mixed water to the mixing tank 6 through the return pipe 160. The amount of the concentrated mixed water to be re-mixed is adjusted by changing a flow rate of the concentrated mixed water to be returned through the return pipe 160. Return of the concentrated mixed water to the mixing tank 6 may be performed continuously during intake of the seawater or may be performed intermittently at predetermined time intervals.

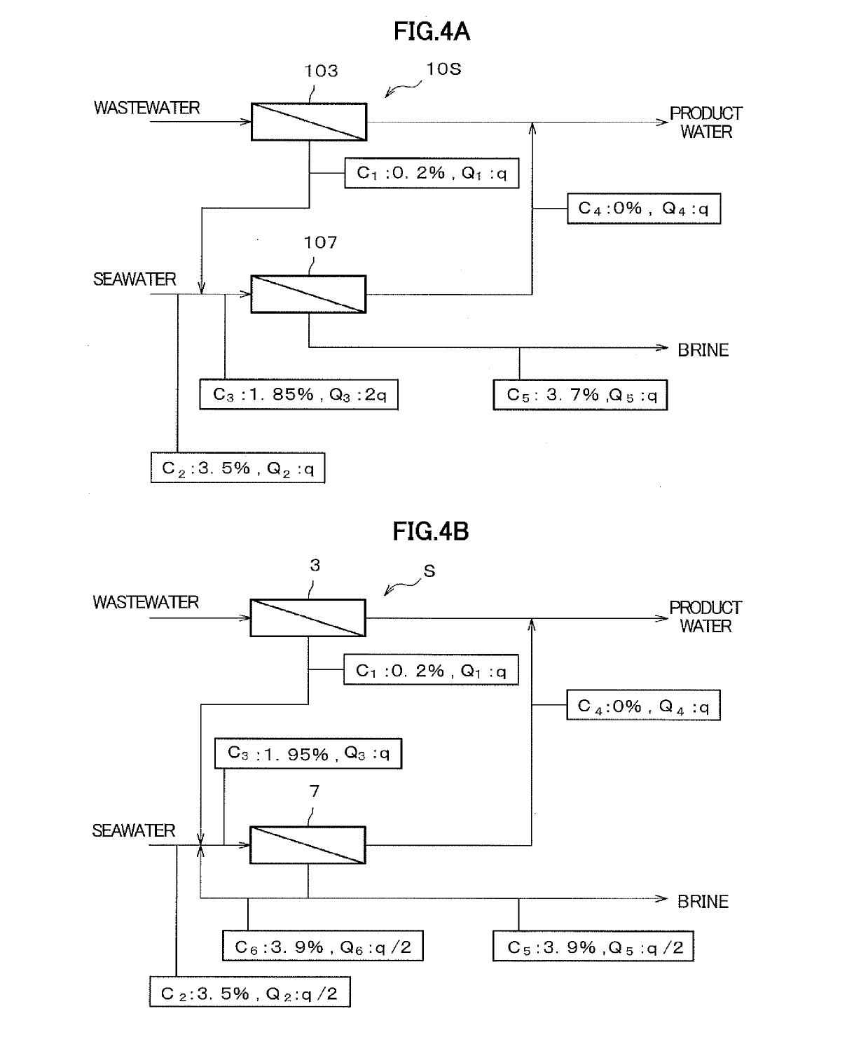

FIG. 4 A is a diagram for explaining operation by return of concentrated mixed water in a water treatment system and showing salt concentration and flow rate in the water treatment system according to the comparative example, and FIG. 4B is a diagram for explaining operation by return of the concentrated mixed water and showing an example of salt concentration and flow rate in the water treatment system according to the embodiment of the present invention. Configuration of the water treatment system 10S according to the comparative example and configuration of the water treatment system S according to the above embodiment are respectively shown in FIG. 4A and FIG. 4B in a simplified manner. FIGS. 4A and 4B respectively exemplify the low pressure RO membrane unit 103 and the high pressure RO membrane unit 107 included in the water treatment system 10S, and the first RO membrane unit 3 and the second RO membrane unit 7 included in the water treatment system S by assuming that recovery rate is 50% and salt removal rate is 100%. Further, FIGS. 4A and 4B show examples in which the flow rate of the wastewater to be supplied and the flow rate of the seawater are set to the same amount, and in the water treatment system S according to the embodiment, an amount of the concentrated mixed water to be returned and an amount of the brine to be drained are set to be the same amount.

In FIGS. 4A and 4B, C₁ is the salt concentration of the concentrated water, and Q₁ is the flow rate thereof. C₂ is the salt concentration of the seawater to be supplied, and Q₂ is the flow rate thereof. C₃ is the salt concentration of the mixed water after merging, and Q₃ is the flow rate thereof. C₄ is the salt concentration of the permeate water in the seawater treatment system, and Q₄ is the flow rate thereof. C₅ is the salt concentration of the concentrated mixed water to be discharged as the brine, and Q₅ is the flow rate thereof. Further, C₆ is the salt concentration of the concentrated mixed water to be returned to the mixed water, and Q₆ is the flow rate thereof.

As shown in FIG. 4A, with the water treatment system 10S according to the comparative example, for example, the wastewater having a salt concentration of about 0.1% and a flow rate of 2 q is subjected to reverse osmosis treatment, and thus the concentrated wastewater has a salt concentration of about 0.2% and a flow rate of q. The concentrated wastewater is merged with the seawater having a salt concentration of about 3.5% and a flow rate of q, and then the mixed water to be supplied to the high pressure RO membrane unit 107 has a salt concentration of about 1.85% and a flow rate of 2 q. Then, by reverse osmosis treatment in the high pressure RO membrane unit 107, the mixed water is separated into the permeate water having a salt concentration of about 0% and a flow rate of q, and the brine having a salt concentration of about 3.7% and a flow rate of q.

In the water treatment system 10S according to the comparative example shown in FIG. 4A, in order to achieve the amount of the product water having a flow rate of 2 q by the sum of the wastewater system and the seawater system, it can be said that the intake facility and the pretreatment facility having sizes respectively corresponding to the flow rate q of the seawater, addition of chemicals corresponding to the flow rate q, and the like are required.

In contrast, as shown in FIG. 4B, with the water treatment system S according to the embodiment, for example, the wastewater having a salt concentration of about 0.1% and a flow rate of q is subjected to reverse osmosis treatment in the first RO membrane unit 3, and thus the concentrated wastewater has a salt concentration of about 0.2% and a flow rate of q. The concentrated wastewater is re-mixed with the seawater having a salt concentration of about 3.5% and a flow rate of q/2 together with the concentrated mixed water to be returned after being separated in the second RO membrane unit 7. As a result, the mixed water to be supplied to the second RO membrane unit 7 has a salt concentration of about 1.95% and a flow rate of q. Further, the concentrated mixed water to be returned has a salt concentration of about 3.9% and a flow rate of q/2, and the brine to be drained has a salt concentration of about 3.9% and a flow rate of q/2 in the same manner.

In the water treatment system S according to the embodiment shown in FIG. 4B, in order to achieve the amount of the product water having a flow rate of 2 q by the sum of the wastewater treatment system and the seawater treatment system, it is understood that the intake facility and the pretreatment facility having sizes respectively corresponding to the flow rate q/2 of the seawater, addition of chemicals corresponding to the flow rate q/2, and the like are sufficient. In this case, the mixed water to be supplied to the second RO membrane unit 7 and the brine to be drained have salt concentrations respectively slightly higher than those in the water treatment system 10S according to the comparative example.

However, an increase of the osmotic pressure due to an increase of the salt concentration is small, and power of the high pressure pump is based on the sum of the osmotic pressure, the water flow path resistance, the membrane permeation resistance and the like, and thus total increase of power cost is small. On the other hand, the intake facility and the pretreatment facility require corrosive-resistant materials, anti-corrosion construction, marine civil engineering work or the like, and thus impact on the cost is very large. Further, the concentrated mixed water can be re-mixed without the pretreatment, because the suspended matter has been previously removed and the pretreatment has also been performed. Therefore, with the water treatment system S, it can be said that the total cost is reduced and it is possible to inexpensively produce the freshwater.

Meanwhile, conventionally, in a typical water treatment system, there are situations where most of the cost to produce the freshwater is occupied by the power cost of the high pressure pump. Therefore, from a viewpoint of inexpensively producing the freshwater satisfying the demand, a water treatment method for maximizing the total amount of the product water in favor of the wastewater treatment system having a reverse osmotic pressure lower than that in the seawater treatment system, is advantageous. It is suitable for the seawater treatment system to be operated when the supply amount of the wastewater is reduced by day and night variation, season variation, weather variation or the like, and the amount of the product water in the wastewater treatment system is insufficient for the demand for the freshwater, for the purpose of compensating for the insufficiency.

Therefore, as the operating method of the water treatment system S, it is a preferred embodiment that the first RO membrane unit 3 having a low reverse osmotic pressure is operated so as to maximize the amount of product water, and a difference between the demand for the freshwater and the amount of the product water from the first RO membrane unit 3, the difference being generated due to insufficiency of the supply amount of the wastewater at this time, is compensated by the amount of the product water from the second RO membrane unit 7. That is, it is a preferred operating method to satisfy the demand by the sum of the amount of the product water from the first RO membrane unit 3 requiring relatively low power cost and the amount of the product water from the second RO membrane unit 7 for which the raw water is almost always sufficient by a large amount of seawater.

When employing such an operating method, it is preferred for the first RO membrane unit 3 to set the supply amount of the wastewater and the recovery rate of the permeate water from a viewpoint of maximizing the flow rate of the permeate water (product water) under a designed pressure and designed flow rate within a variation of the supply amount of the wastewater. In this case, by setting the supply amount and the recovery rate, the flow rate of the concentrated wastewater is approximately determined. Therefore, under the flow rate of the concentrated wastewater determined in this way, the second RO membrane unit 7 is operated so as to obtain the product water compensating for the difference between the demand of the freshwater and the amount of the product water from the first RO membrane unit 3 by adjusting the return amount of the concentrated mixed water or the intake amount of the seawater.

Under a condition that the amount of the product water to be produced in the wastewater treatment system and the product water to be produced in the seawater treatment system are approximately determined in this way, it is preferable to adjust the amount of the concentrated mixed water to be re-mixed through the return pipe 160 with respect to the seawater and the wastewater which are mixed together in the mixing tank 6, based on at least one of the salt concentration of the mixed water, the salt concentration of the wastewater or the treated wastewater, and the amount of the wastewater or the treated wastewater. That is, it is preferable to increase or decrease the flow rate of the concentrated mixed water to be returned to the mixing tank 6 through the return pipe 160 based on a variation of the flow rate of the wastewater or the treated wastewater, or a variation of the salt concentration of the wastewater or the treated wastewater.

The amount of the wastewater (or the treated wastewater) as a reference for adjusting the amount of the concentrated mixed water may be any of the flow rate of the wastewater (or the treated wastewater) supplied to the first RO membrane unit 3, the flow rate of the permeate water (product water) separated in the first RO membrane unit 3, and the flow rate of the concentrated mixed water separated in the first RO membrane unit 3. In general, these flow rates are substantially uniquely determined by design, specification, operating conditions and the like of the first RO membrane unit 3. Therefore, it is possible to know the flow rate of the wastewater to be mixed in the mixing tank 6, for example, by installing a flowmeter on a conduit to measure one of the flow rates.

In particular, when the flow rate of the wastewater or the treated waste water is reduced, the adjustment of the amount of the concentrated mixed water based on the amount of the wastewater (or the treated waste water) is performed so that the concentration of the concentrated mixed water is not equal to or more than a concentration which is determined so that the operating costs are appropriate. That is, when the flow rate of the wastewater or the treated waste water is reduced, the return amount of the concentrated mixed water is adjusted so that the concentration of the mixed water to be supplied is not too high, and the amount of the water supplied to the second RO membrane unit 7, which is required to satisfy the demand, is ensured by adjusting the intake amount of the seawater. In this case, it is preferred that the flow rate of the concentrated mixed water to be returned to the mixing tank 6 through the return pipe 160 is less than the flow rate of the seawater to be sent to the mixing tank 6, so as to prevent increase of the salt concentration.

Further, the salt concentration of the wastewater (or the treated wastewater) as a reference for adjusting the amount of the concentrated mixed water may be one of the salt concentration of the wastewater (or the treated wastewater) supplied to the first RO membrane unit 3, and the salt concentration of the concentrated mixed water separated in the first RO membrane unit 3. In general, these salt concentrations are substantially uniquely determined by the design, the specification, the operating conditions and the like of the first RO membrane unit 3. Therefore, it is possible to know the salt concentration of the wastewater to be mixed in the mixing tank 6, for example, by installing a salinity meter on a conduit to measure one of the salt concentrations.

In particular, when the salt concentration of the wastewater or the treated waste water is increased, the adjustment of the amount of the concentrated mixed water based on the salt concentration of the wastewater (or the treated waste water) is performed so as to reduce the return amount of the concentrated mixed water. That is, when the salt concentration of the wastewater or the treated waste water is increased, a drainage volume of the brine is increased while reducing the return amount of the concentrated mixed water. In this case, it is preferred that the flow rate of the concentrated mixed water to be returned to the mixing tank 6 through the return pipe 160 is less than the flow rate of the seawater to be sent to the mixing tank 6, so as to prevent increase of the salt concentration.

Further, the salt concentration of the mixed water as a reference for adjusting the amount of the concentrated mixed water may be one of the salt concentration of the mixed water supplied to the second RO membrane unit 7 and the salt concentration of the mixed water which is calculated from the flow rate and the salt concentration of the seawater and the wastewater (or the treated wastewater). The salt concentration of the mixed water can be measured by installing the salinity meter in the mixing tank 6 or at an outlet side thereof to measure the salt concentration. Further, the flow rate of the mixed water may be measured by installing, for example, a water level meter or a flowmeter for measuring a flow rate at the outlet, so as to be referenced for calculation of the salt concentration of the mixed water.

In particular, when the salt concentration of the mixed water is increased, the adjustment of the amount of the concentrated mixed water based on the salt concentration of the mixed water is performed so as to reduce the return amount of the concentrated mixed water. That is, when the salt concentration of the mixed water is increased, the drainage volume of the brine is increased while reducing the return amount of the concentrated mixed water. In this case, it is preferred that the flow rate of the concentrated mixed water to be returned to the mixing tank 6 through the return pipe 160 is less than the flow rate of the seawater to be sent to the mixing tank 6, so as to prevent increase of the salt concentration.

In this way, by increasing or decreasing the flow rate of the concentrated mixed water to be re-mixed with the mixed water based on a variation of the flow rate of the wastewater or the treated wastewater, or a variation of the salt concentration of the wastewater or the treated wastewater, it is possible to reduce accumulation of the salt due to re-mixing of the concentrated mixed water while maximally reducing the intake amount of the seawater. Since the salt is properly discharged as the brine, the osmotic pressure in the second RO membrane unit 7 is unlikely to increase with circulation of the concentrated mixed water, and thus the power cost of the high pressure pump 25 and the like is suppressed as much as required.

Note that, the above water treatment systems (S, 2S) may include, instead of the wastewater treatment tank 1, a combination of a treatment tank to perform removal/decomposition process of organic matter and inorganic matter, and a treatment tank to perform clarification process of activated sludge, suspended matter and the like. The removal/decomposition process is not limited to the biological treatments by microorganisms, but may be the physicochemical processes such as the adsorption treatment, the ion exchange treatment, the redox agent treatment, the ozone treatment or ultraviolet treatment, or a combination of these treatments. Further, the clarification process may be the physicochemical processes such as sedimentation process, coagulation sedimentation process, adsorption process or flotation process, filtration processes such as sand filtration, membrane separation processes by microfiltration membrane, ultrafiltration membrane or the like, or a combination of these processes. Furthermore, the removal/decomposition process may be omitted depending on the nature of the wastewater.

Further, in the above water treatment systems (S, 2S), installation of the water supply tank 2 may be omitted. It is possible to send the wastewater directly to the first RO membrane unit 3 from the wastewater treatment tank 1 without the water supply tank 2.

Further, in the above water treatment systems (S, 2S), installation of the mixing tank 6 may be omitted. It is possible to form a conduit connecting to the second RO membrane unit 7 by a junction pipe joined together with a pipe in which the concentrated wastewater is sent, a pipe in which the seawater is sent, and a pipe in which the concentrate mixed water is sent, thereby employing a configuration in which the concentrated wastewater, the seawater and the concentrated mixed water are mixed together in the conduit.

Further, the above water treatment systems (S, 2S) may include the energy recovery device 8 of a configuration other than the positive displacement pump. Such an energy recovery device 8 may be configured to recover any energy of the flow rate or the pressure of the concentrated mixed water. Further, the energy recovery device 8 may be configured to include an appropriate energy conversion mechanism such as a piston mechanism or a turbine mechanism by an impeller, a water turbine or the like.

Further, in the above water treatment systems (S, 2S), installation of the concentrated water receiving tank 9 may be omitted. It is possible to employ a configuration in which a pipe, through which the concentrated mixed water separated in the second RO membrane unit 7 is sent, forms a conduit to be branched into the return pipe 160 and a pipe through which the brine is discharged. In this branch point, it is possible to provide, for example, a flow control valve, or a distribution valve for distributing the concentrated mixed water separated in the second RO membrane unit 7 into the concentrated mixed water to be returned to the mixing tank 6 and the brine to be drained.

### REFERENCE SIGNS LIST

1: wastewater treatment tank
2: water supply tank
3: first RO membrane unit (first reverse osmosis treatment device)
4: filter device
5: filtered water tank
6: mixing tank (mixing unit)
7: second RO membrane unit (second reverse osmosis treatment device)
8: energy recovery device
9: concentrated water receiving tank
140: branch pipe
160: return pipe
S: water treatment system

1. A water treatment system, comprising:
a first reverse osmosis treatment device for separating wastewater or treated wastewater into desalinated permeate water and concentrated wastewater by reverse osmosis treatment;
a mixing unit for mixing the separated concentrated wastewater and intake seawater;
a second reverse osmosis treatment device for separating mixed water obtained by mixing the concentrated wastewater and the seawater into desalinated permeate water and concentrated mixed water by reverse osmosis treatment; and
a return pipe for returning a portion of the separated concentrated mixed water to the mixing unit.

2. The water treatment system according to claim 1, further comprising
a supply pipe for supplying the wastewater or the treated wastewater to the mixing unit.

3. A water treatment method comprising the following steps:
mixing intake seawater with wastewater or treated wastewater;
separating mixed water obtained by mixing the seawater with the wastewater or the treated wastewater into desalinated permeate water and concentrated mixed water by reverse osmosis treatment;
re-mixing a portion of the concentrated mixed water with the mixed water obtained by mixing the seawater with the wastewater or the treated wastewater; and
producing freshwater by re-separating mixed water re-mixed with the concentrated mixed water into desalinated permeate water and concentrated mixed water by reverse osmosis treatment.

4. The water treatment method according to claim 3,
wherein the intake seawater is mixed with concentrated water which has been previously separated from wastewater or treated wastewater by reverse osmosis treatment.

5. The water treatment method according to claim 3,
wherein an amount of concentrated mixed water to be re-mixed is adjusted based on at least one of an amount of the wastewater or the treated wastewater, a salt concentration of the wastewater or the treated wastewater, and a salt concentration of the mixed water.
